(19) United States
(12) Patent Application Publication
(10) Pub. No.: US 2006/0045713 A1
(43) Pub. Date: Mar. 2, 2006

(54) Device for measuring a maximum load allowed for lift platforms

(75) Inventor: Riccardo Magni, Modena (IT)

Correspondence Address: YOUNG & THOMPSON, 745 SOUTH 23RD STREET, 2ND FLOOR, ARLINGTON, VA, 22202, US

(73) Assignee: MANITOU COSTRUZIONI INDUSTRIALI S.R.L., MODENA (IT)

(21) Appl. No.: 11/062,919

(22) Filed: Feb. 23, 2005

(30) Foreign Application Priority Data
Aug. 31, 2004 (IT) MO2004A000217

(51) Int. Cl. B66C 23/00

(52) U.S. Cl. 414/687

(57) ABSTRACT

A raisable work platform has a horizontal support plane which is predisposed to support a vertical load and is associable to a telescopic lift arm. The device includes: a first joint element, solidly constrained to the support plane; a second joint element, associable to a free end of the telescopic lift arm. Members for connecting, predisposed to connect the first joint element to the second joint element, enable the joint elements to translate only relatively. Members for supporting, interpositioned between the first joint element and the second joint element, are predisposed for supporting the total vertical load of the platform, constituted by the weight of the platform itself and the load borne thereon, through elastic members. Elements for measuring are associated to the members for supporting, which measuring elements signal a reaching of a predetermined deformation of the elastic members.

### BACKGROUND of the INVENTION

The device is usefully applied in lift platforms of a type in which a horizontal support is predisposed for supporting a vertical load and is associable to a telescopic lift arm. The horizontal platform can be provided with lateral barriers and support, for example, an operator having equipment which is to be lifted to determined heights for performing operations on apparatus located above ground level.

Various existing standards demand that work platforms be provided with devices for measuring the vertical load acting on the support plane. If the load exceeds a certain safety value, safety means intervene for blocking the platform.

Prior-art devices for measuring vertical load generally comprise a bearing structure, associated to a telescopic arm, which inferiorly supports the work platform. Means for measuring the vertical load are interpositioned between the bearing structure and the platform.

Devices of this type exhibit drawbacks constituted by the considerable additional mass due to the bearing structure itself as well as the difficulty of realising a bearing structure which is sufficiently rigid not to deform by effect of the vertical load, compromising the accuracy of the measurement.

Other known-type devices comprise strain-gauge cells associated to the pivot or pivots which connect the work platform to the extensible arm. The devices of this type exhibit the considerable drawback of being sensitive to the position of the load on the work platform, i.e. to the torque generated by the vertical load with respect to the attachment point of the platform, and as a result the measurement taken and provided does not entirely depend on the entity of the vertical load.

The main aim of the present invention is to provide a device for measuring the vertical load in liftable work platforms, which enables the drawbacks of the prior art to be overcome.

### SUMMARY of the INVENTION

A raisable work platform comprises a horizontal support plane which is predisposed to support a vertical load and is associable to a telescopic lift arm. The device comprises: a first joint element, solidly constrained to the support plane; a second joint element, associable to a free end of the telescopic lift arm. Means for connecting, predisposed to connect the first joint element to the second joint element, enable the joint elements to translate only relatively. Means for supporting, interpositioned between the first joint element and the second joint element, are predisposed for supporting the total vertical load of the platform, constituted by the weight of the platform itself and the load borne thereon, through elastic means. Means for measuring are associated to the means for supporting, which means for measuring signal a reaching of a predetermined deformation of the elastic means.

### BRIEF DESCRIPTION of the DRAWINGS

Further characteristics and advantages of the present invention will better emerge from the detailed description that follows, illustrated purely by way of a non-limiting example in the accompanying figures of the drawings, in which:

FIG. 1 is a schematic view of the device of the present invention;

FIG. 2 is a partially-sectioned view of a detail of the device of FIG. 1;

FIG. 3 is a view from above of a detail of FIG. 2.

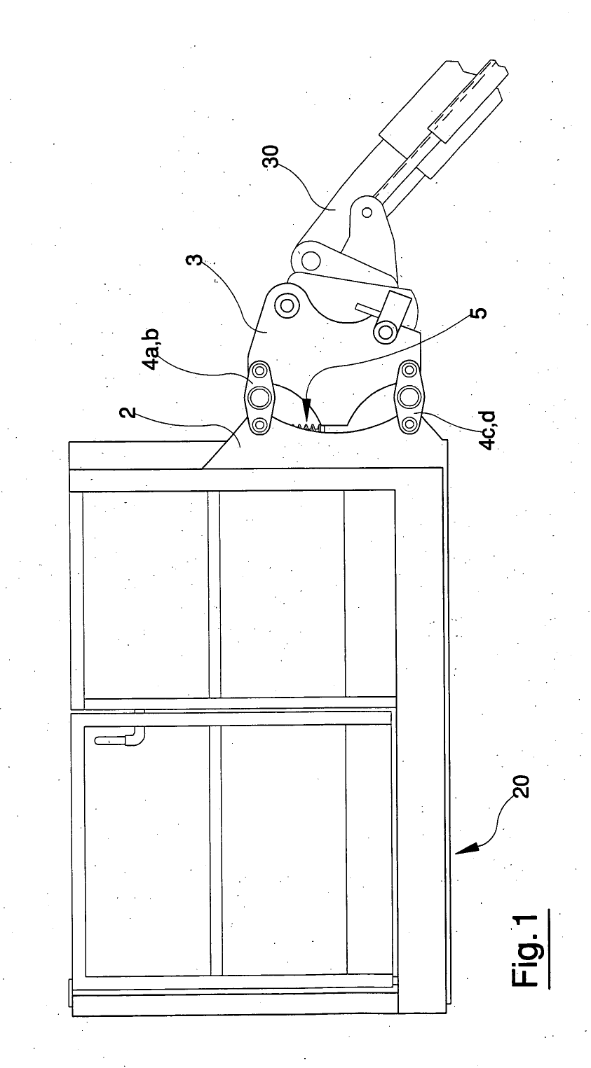

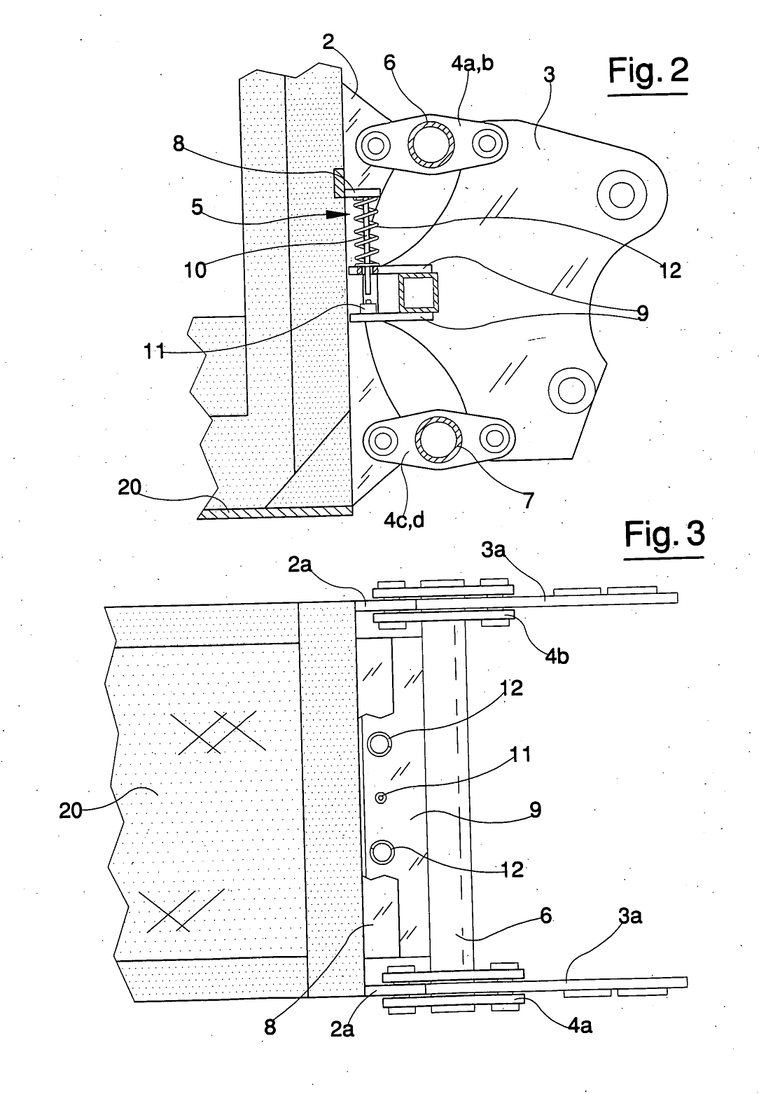

### DESCRIPTION of the PREFERRED EMBODIMENTS

With reference to the figures of the drawings, the device of the present invention is applicable to a lift work platform comprising a horizontal support plane 20 which is predisposed to support a vertical load and is associable to a telescopic lift arm 30.

The device comprises a first joint element 2, solidly constrained to the support plane 20, and a second joint element 3, associable to a free end of the telescopic lift arm 30. The device further comprises means for connecting which are predisposed to connect the first joint element 2 to the second joint element 3.

The means for connecting are for preventing rotations which change the relative orientation of the joint elements 2 and 3, so that the first joint element 2 moves parallel to itself with respect to the second joint element 3.

The means for connecting, predisposed to connect the first joint element 2 to the second joint element 3, comprise at least two first con rods 4a, 4c, parallel to one another and hinged at ends thereof to the first joint element 2 and the second joint element 3. The first con rods 4a and 4c are hinged about horizontal and parallel rotation axes in such a way that the first con rods 4a, 4c and the first joint element 2 and the second joint element 3 form between them a four-bar hinge having a rotation plane on which the first con rods 4a, 4c rotate.

The means for connecting predisposed for connecting the first joint element 2 to the second joint element 3 also comprise at least two second con rods 4b, 4d which are hinged at ends thereof to the first joint element 2 and the second joint element 3. Similarly to the first con rods, the second con rods 4b, 4d are hinged about horizontal and parallel rotation axes and rotate on a parallel plane to the rotation plane of the first con rods 4a, 4c. Each of the two second con rods 4b, 4d, is arranged parallel to a respective first con rod 4a, 4c and is connected to said first con rod 4a or 4c by a bar 6, 7 which is perpendicular to the rotation plane of the four-bar hinge.

Means for support 5 are interpositioned between the first joint element 2 and the second joint element 3, which means for support 5 are predisposed, through elastic means, for supporting the total vertical load on the platform, which total load is constituted by the weight of the platform itself and the load placed upon it.

The means for support 5 comprise at least a first striker 8, solidly constrained to the first joint element 2, which striker 8 comprises at least a first flat surface 8a arranged parallel to the rotation plane of the four-bar hinge. At least a second striker 9 is solidly constrained to the second joint element 3 and comprises at least a second flat surface 9a arranged parallel to the rotation plane of the four-bar hinge. The two flat surfaces 8a, 9a, are arranged parallel and one frontally to the other. The elastic means are interpositioned between the first striker 8 and the second striker 9, in contact with the flat surfaces 8a, 9a, and deform at least partially due to the effect of the vertical load. The connection between the first joint element 2 and the second joint element 3, in a four-bar hinge arrangement, allows the second joint element 3 to displace, with respect to the first joint element 2, only according to a circular trajectory and without modifying its inclination. In other words, the means for connecting defined by the first and second con rods do not react to a vertical load. In this way the vertical load is entirely transmitted to the means for support 5, independently of its position on the support plane 20. By effect of the vertical load, the elastic means 12, preferably constituted by a plurality of helix springs in parallel alignment, compress proportionally to the entity of the vertical load.

Means for detecting are interpositioned between the first joint element 2 and the second joint element 3, which signal when a predetermined amount of deformation has occurred in the elastic means.

The means for detecting essentially comprise a rod 10 which at a first end thereof is constrained to the flat surface 8a of the first striker 8, while a free second end faces towards the flat surface of the second striker 9. A switch 11 is solidly mounted on the flat surface of the second striker 9 and is arranged in a frontal position with respect to the free end of the rod 10. The switch 11 is located at a distance from the free end of the rod 10 so that, if the vertical load acting on the support plane 20 exceeds a predetermined value, the switch 11 enters into contact with the free end of the rod 10 and generates a corresponding signal.

The construction of the device is as follows: the first joint element 2 comprises two walls 2a arranged parallel to the rotation planes of the first con rods 4a, 4c and the second con rods 4b, 4d. The first con rods 4a, 4c are hinged at a first end thereof to a wall 2a of the first joint element 2. The second con rods 4b, 4d are hinged at a first end thereof to the other wall 2a of the first joint element 2. The second joint element 3 comprises two walls 3a arranged parallel to the rotation planes of the first con rods 4a, 4c and the second con rods 4b, 4d. The first con rods 4a, 4c are hinged at second ends thereof to a wall 3a of the second joint element 3. The second con rods 4b, 4d are hinged at second ends thereof to the other wall 3a of the second joint element 3. Each of the first and second con rods, 4a, 4b, 4c and 4d is defined by two parallel elements which are located on opposite sides of the walls 2a, 3a of the first joint element 2 and the second joint element 3, and are hinged at ends thereof to the walls 2a and 3a.

The device for measuring a vertical load on lifting work platforms of the invention offers notable advantages.

Firstly, it is extremely simple, economical and reliable. The four-bar hinge design also enables precise measurement of the load, with no influence of the vertical load acting on the support plane, thus guaranteeing an absolutely reliable operation of the work platform. Furthermore the device does not require predisposition of bearing structures for supporting the support plane, which avoids any increase in weight of the work plane.

1. A device for measuring a maximum load allowed for lift platforms, in which a raisable work platform comprises a horizontal support plane which is predisposed to support a vertical load and is associable to a telescopic lift arm, comprising: a first joint element, solidly constrained to the support plane; a second joint element, associable to a free end of the telescopic lift arm; means for connecting, predisposed to connect the first joint element to the second joint element, for preventing rotations which change a relative orientation of the joint elements; means for supporting, interpositioned between the first joint element and the second joint element and predisposed for supporting the total vertical load of the platform through elastic means; means for measuring being associated to the means for supporting, which means for measuring signal a reaching of a predetermined deformation of the elastic means.

2. The device of claim 1, wherein the means for connecting, predisposed to connect the first joint element to the second joint element, comprise at least two first con rods, parallel to one another and hinged at ends thereof to the first joint element and the second joint element about horizontal and parallel rotation axes, in such a way that the first con rods and the first joint element and the second joint element form between them a four-bar hinge having a rotation plane on which the first con rods rotate.

3. The device of claim 2, wherein it comprises at least two second con rods which are hinged at ends thereof to the first joint element and to the second joint element about horizontal and parallel rotation axes, the second con rods rotating on a parallel plane to the rotation plane of the first con rods, each of which two second con rods is arranged parallel to a respective first con rod and is also connected to the respective first con rod by means of a bar which is perpendicular to a rotation plane of the four-bar hinge.

4. The device of claim 1, wherein the means for supporting comprise; at least a first striker, solidly constrained to the first joint element, which first striker 8 comprises at least a first flat surface arranged parallel to the rotation plane of the four-bar hinge; at least a second striker, solidly constrained to the second joint element, which comprises at least a second flat surface arranged perpendicular to the rotation plane of the four-bar hinge; the elastic means being interpositioned between the first striker and the second striker, and being in contact with the first and second flat surfaces, and deforming a least partially due to an effect of a vertical load.

5. The device of claim 1, wherein the means for detecting for signalling a reaching of a predetermined amount of deformation of the elastic means comprise: a rod which at a first end thereof is constrained to the first flat surface of the first striker and at a free second end thereof is facing the second flat surface of the second striker; a switch being solidly mounted on the second flat surface of the second striker and arranged in a frontal position with respect to the free second end of the rod at a distance therefrom which is such that if the vertical load acting on the support plane exceeds a predetermined value, the switch enters into contact with the free second end of the rod, and generates a signal.

6. The device of claim 1, wherein the first joint element comprises two walls arranged parallel to the rotation planes of the first con rods and the second con rods, the first con rods being hinged at first ends thereof to a first wall of the first joint element, the second con rods being hinged at first ends thereof to another wall of the first joint element.

7. The device of claim 1, wherein the second joint element comprises two walls arranged parallel to the rotation planes of the first con rods and the second con rods, the first con rods being hinged at second ends thereof to a first wall of the second joint element, the second con rods being hinged at second ends thereof to another wall of the second joint element.

8. The device of claim 1, wherein each of the first con rods and the second con rods is defined by two parallel elements located on opposite sides with respect to the walls of the first joint element and the second joint element, the two parallel elements being hinged at ends thereof to the walls.

9. The device of claim 4, wherein the means for detecting for signalling a reaching of a predetermined amount of deformation of the elastic means comprise: a rod which at a first end thereof is constrained to the first flat surface of the first striker and at a free second end thereof is facing the second flat surface of the second striker; a switch being solidly mounted on the second flat surface of the second striker and arranged in a frontal position with respect to the free second end of the rod at a distance therefrom which is such that if the vertical load acting on the support plane exceeds a predetermined value, the switch enters into contact with the free second end of the rod, and generates a signal.
